(19) United States
(12) Patent Application Publication
(10) Pub. No.: US 2015/0357068 A1
(43) Pub. Date: Dec. 10, 2015

(54) Dual mode nuclear battery and radiation enhanced thermo-electron engine

(71) Applicant: Joshua Ryan Smith, Washington, DC (US)

(72) Inventor: Joshua Ryan Smith, Washington, DC (US)

(21) Appl. No.: 14/451,430

(22) Filed: Aug. 5, 2014

Related U.S. Application Data
(60) Provisional application No. 61/862,083, filed on Aug. 5, 2013.

(51) Int. Cl. G21H 1/10

(52) U.S. Cl. CPC G21H 1/103

(57) ABSTRACT

Techniques are provided for emission of an electron current from an electrode and converting energy released by nuclear decay to useful electrical work. An electrode assembly is provided which includes an emitter material and a radioactive source such that nuclear decay from the radioactive source causes or enhances electron emission from the electrode. A thermoelectron energy converter is provided which includes an emitter electrode, a radioactive source in the vicinity of the emitter electrode, a collector electrode, an enclosure, and electrical leads. Nuclear decay from the radioactive source causes or enhances electron emission from the emitter electrode. The electrons emitted from the emitter electrode travel to the collector electrode and can be driven through an external circuit, outputting electrical power.

### CROSS-REFERENCE TO RELATED APPLICATIONS

This application claims priority from U.S. Provisional Application No. 61/862,083 filed on Aug. 5, 2013, the entirety of which is incorporated by reference herein.

### TECHNICAL FIELD

The disclosed subject matter relates generally to direct energy conversion devices and methods of making the same, and more specifically to thermoelectron engines and vacuum/rarefied gas based energy conversion devices which rely on nuclear radiation with or without additional heat to produce electrical power.

### BACKGROUND

Vacuum and rarefied gas based electronic devices are devices in which two or more electrodes are enclosed in a container. In the case of a vacuum device, the enclosed volume is evacuated of atmosphere to an acceptably low pressure for the desired application. In the case of a rarefied gas based device, the enclosure is first evacuated to an acceptably low pressure, and then the volume is backfilled with a particular gas or mixture of gases to a particular pressure; the composition and pressure of gases are chosen for the desired application of the device. Many types of electronic devices can be created in this way, and the desired behavior of the device can be achieved by manipulating any of the following or a combination thereof: electric or magnetic fields within the device, the level of vacuum within the device, the composition of gas within the device, or the physical properties, geometries, and arrangement of electrodes within the device.

One such device is known as a “thermoelectron engine,” sometimes referred to as a “thermoelectron energy converter” and abbreviated as TEC. The term “thermoelectron” is preferred here over the more commonly used “thermionic” to highlight the fact that electrons, not ions, are involved in the operation of such devices. The TEC is comprised of at least two electrodes. Stimulus in the form of heat is added to one of the electrodes, known as the “emitter” or “cathode.” This stimulus results in a current of electrons escaping the emitter via the phenomenon of thermoelectron emission. A second electrode known as the “collector” or “anode” is located nearby the emitter and is configured such that heat is removed from the collector. The electron current escaping the emitter is absorbed by the collector. If an external electrical load is wired to the emitter and collector electrodes, the current traveling from the emitter electrode to the collector electrode within the TEC will be driven through the external load. In this way the TEC converts the heat stimulating the emitter electrode into electricity.

If the enclosure is evacuated of atmosphere, the device is known as a “vacuum TEC.” The enclosure may be backfilled with a gas or mixture of gases to achieve some desired effect such as improving some aspect of device performance; in this case the device is known as a “vapor TEC.” Electrodes other than the emitter and collector may be present within the device to provide an electric field within the device, and magnetic fields may also be applied within the device in order to improve some aspect of performance of the device.

Thermoelectron emission is the emission of electrons from a solid material held at an elevated temperature. The increased temperature increases the population of electrons at higher energy states within the material. Electrons with sufficiently high energy near the surface of the material escape as the thermoelectron current. The magnitude of the thermoelectron emission current is determined by the temperature of the material and the material's physical properties, particularly the energy barrier which electrons encounter at the surface of the material, commonly known as the “work function.”

Nuclear decay occurs when an atomic nucleus spontaneously breaks apart into two smaller nuclei. During this process, various forms of radiation can be emitted depending on the details of the decay. Radiation can occur in the form of alpha (α) particles which are identical to helium nuclei, beta (β) particles which are electrons, or gamma (γ) rays which are high energy photons. Depending on the details of the nuclear decay and the size of the radioactive specimen, the temperature of the radioactive specimen can be elevated above the ambient temperature, even while the specimen emits nuclear radiation.

If α or β radiation strikes a semiconductor, energy from the α or β particle can be transferred to electrons within the material. Such energy transferred to an electron within the material results in the electron occupying a higher energetic state, a condition commonly known as “excitation.” Each α or β particle carries a large amount of energy and can therefore promote many electrons residing within the material into higher energetic states. Electrons within the material excited to higher energetic states in this way are referred to as “secondary electrons.” The electrons excited from nuclear radiation as it passes through the semiconductor is referred to as the “secondary electron cascade.” As the amount of nuclear radiation striking the semiconductor increases, the population of excited electrons within the material increases. The effect of the excitation of the population of electrons within a material can combine with the phenomenon of thermoelectron emission to result in an enhanced thermoelectron emission of electrons from a material.

### SUMMARY

Certain embodiments of the disclosed subject matter include an emitter electrode assembly. The emitter electrode assembly can include an emitter material in the vicinity of one or more radioactive sources experiencing nuclear decay.

In any of the embodiments described herein, the radioactive source can emit nuclear radiation in the form of α, β, or γ radiation.

In any of the embodiments described herein, the temperature of the radioactive source can be higher than ambient temperature as a result of the nuclear decay of the radioactive source.

In any of the embodiments described herein, heat from a source external to the emitter material or radioactive sources can be applied to the emitter material.

In any of the embodiments described herein, heat from a source external to the emitter material or radioactive sources can be applied to the emitter electrode assembly.

In any of the embodiments described herein, nuclear radiation can strike the emitter material and can transfer energy in the form of heat to the emitter material. The heat can increase the temperature of the emitter material and the emitter material can emit a thermoelectron emission current.

In any of the embodiments described herein, a radioactive source can be in direct thermal contact with the emitter material. Heat can be transferred from the radioactive source to the emitter material and the temperature of the emitter material can be increased above ambient temperature. The emitter material can emit a thermoelectron emission current.

In any of the embodiments described herein, nuclear radiation can strike the emitter material and can generate a population of excited electrons within the material. An emission current comprised of some of the population of excited electrons can be emitted from the emitter material.

In any of the embodiments described herein, the population of excited electrons can enhance the thermoelectron emission current from the emitter material.

In any of the embodiments described herein, the emitter electrode can be in electrical contact with an electrical lead or wire. The electrical lead can be connected to an electrical circuit external to the emitter electrode, or the electrical lead can be connected to ground. Electrons emitted from the emitter electrode can be replenished by a current of electrons entering the emitter electrode through the electrical lead.

Certain embodiments of the disclosed subject matter include a thermoelectron energy converter (TEC). The TEC can include an emitter electrode and a collector electrode enclosed in a container. The emitter electrode and collector electrode are separated from one another by a distance. The container may be evacuated, partially evacuated, or contain some atmosphere of gas or a mixture of gases. The emitter electrode can be in electrical contact with a lead or wire which penetrates the container and terminates at an electrical terminal outside the container. The collector electrode can be in electrical contact with a lead or wire which penetrates the container and terminates at an electrical terminal outside the container.

In any of the embodiments described herein, the TEC can include one or more materials experiencing nuclear decay in the vicinity of the emitter electrode and emitting nuclear radiation in the form of one or a combination of α, β, or γ radiation.

In any of the embodiments described herein, the TEC can include one or more radioactive sources whose temperature can be higher than ambient temperature as a result of the nuclear decay of the radioactive source.

In any of the embodiments described herein, heat can be transferred to the emitter electrode by one or a combination of the following: nuclear radiation from the radioactive source, heat conducted directly from the radioactive source to the emitter electrode as a result of the radioactive source experiencing nuclear decay, or heat from a source external to the emitter electrode and apart from any heat transferred from the radioactive source to the emitter electrode.

In any of the embodiments described herein, the nuclear radiation that strikes the emitter electrode can transfer energy to the electrons within the emitter electrode, and a population of electrons within the emitter electrode can be excited to higher energy states. An electron current comprised of some of the population of excited electrons within the emitter electrode can be emitted from the emitter electrode. The electron current emanating from the emitter electrode can travel to the collector electrode where it is absorbed.

In any of the embodiments described herein, heat transferred to the emitter electrode can generate a thermoelectron current emanating from the emitter electrode. The electron current emanating from the emitter electrode can travel to the collector electrode where it is absorbed.

In any of the embodiments described herein, the thermoelectron current from the emitter electrode can be enhanced by the population of excited electrons within the emitter electrode generated by the nuclear radiation striking the emitter electrode from the radioactive source. The electron current emanating from the emitter electrode can travel to the collector electrode where it is absorbed.

In any of the embodiments described herein, an external electrical circuit can be connected between the two external terminals of the TEC. Current emanating from the emitter electrode and absorbed at the collector electrode can be driven through the external electrical circuit.

### BRIEF DESCRIPTION OF THE DRAWINGS

For a more complete understanding of the invention, reference is made to the following description and accompanying drawings, in which:

FIG. 1 shows an emitter electrode assembly with emission layer and radioactive source in which nuclear radiation increases the temperature of the emission layer and causes a thermoelectron current;

FIG. 2 shows an emitter electrode assembly with emission layer in direct thermal contact with a radioactive source in which nuclear decay increases the temperature of the emission layer and causes a thermoelectron current;

FIG. 3 shows an emitter electrode assembly with emission layer and radioactive source in which nuclear radiation generates a population of excited electrons within the emission layer and causes an emission current;

FIG. 4 shows an emitter electrode assembly with emission layer and radioactive source in which nuclear radiation both heats the emission layer and generates a population of excited electrons within the emission layer and causes an enhanced thermoelectron current;

FIG. 5 shows an emitter electrode assembly with emission layer in direct contact with a radioactive source in which nuclear decay increases the temperature of the emission layer and nuclear radiation generates a population of excited electrons within the emission layer, causing an enhanced thermoelectron current;

FIG. 6 shows an emitter electrode assembly with emission layer and radioactive source in which nuclear radiation generates a population of excited electrons within the emission layer and an external source of heat is applied, causing an enhanced thermoelectron current;

FIG. 7 shows a TEC in which nuclear radiation from a radioactive source transfers heat to the emission layer and causes a thermoelectron current;

FIG. 8 shows a TEC in which nuclear decay from a radioactive source transfers heat to the emission layer and causes a thermoelectron current;

FIG. 9 shows a TEC in which nuclear radiation from a radioactive source generates a population of excited electrons within the emission layer and causes an emission current;

FIG. 10 shows a TEC in which nuclear radiation from a radioactive source generates a population of excited electrons within the emission layer and increases the temperature of the emission layer, causing an enhanced thermoelectron current;

FIG. 11 shows a TEC in which nuclear decay from a radioactive source increases the temperature of an emission layer while nuclear radiation generates a population of excited electrons within the emission layer, causing an enhanced thermoelectron current;

FIG. 12 shows a TEC in which nuclear radiation from a radioactive source generates a population of excited electrons within the emission layer while an external heat source increases the emission layer temperature, causing an enhanced thermoelectron current; and

FIG. 13 shows a TEC in which nuclear radiation from multiple radioactive source generates a population of excited electrons within the emission layer while an external heat source increases the emission layer temperature, causing an enhanced thermoelectron current.

### DETAILED DESCRIPTION

Reference now will be made in detail to embodiments of the disclosed subject matter. Such embodiments are provided by way of explanation of the disclosed subject matter, and the embodiments are not intended to be limiting. In fact, those of ordinary skill in the art can appreciate upon reading the specification and viewing the drawings that various modifications and variations can be made.

Before explaining at least one embodiment of the disclosed subject matter in detail, it is to be understood that the disclosed subject matter is not limited in its application to the details of construction and to arrangements of the components set forth in the following description or illustrated in the drawings. The disclosed subject matter can be manifested in other embodiments and of being practiced and carried out in various ways. Also, it is to be understood that the phraseology and terminology employed herein are for the purpose of description and should not be regarded as limiting. Numerous embodiments are described in this patent application, and are presented for illustrative purposes only. The described embodiments are not intended to be limiting in any sense. The disclosed subject matter is widely applicable to numerous embodiments, as is readily apparent from the disclosure herein. Those skilled in the art will recognize that the disclosed subject matter can be practiced with various modifications and alterations. Although particular features of the disclosed subject matter can be described With reference to one or more particular embodiments or figures, it should be understood that such features are not limited to usage in the one or more particular embodiments or figures with reference to which they are described.

As such, those skilled in the art will appreciate that the conception, upon which this disclosure is based, can readily be utilized as a basis for the designing of other structures, methods and systems for carrying out the several purposes of the disclosed subject matter. It is important, therefore, that the disclosed subject matter be regarded as including equivalent constructions to those described herein insofar as they do not depart from the spirit and scope of the disclosed subject matter.

In addition, features illustrated or described as part of one embodiment can be used on other embodiments to yield a still further embodiment. Additionally, certain features can be interchanged With similar devices or features not mentioned yet which perform the same or similar functions. It is therefore intended that such modifications and variations are included within the totality of the disclosed subject matter.

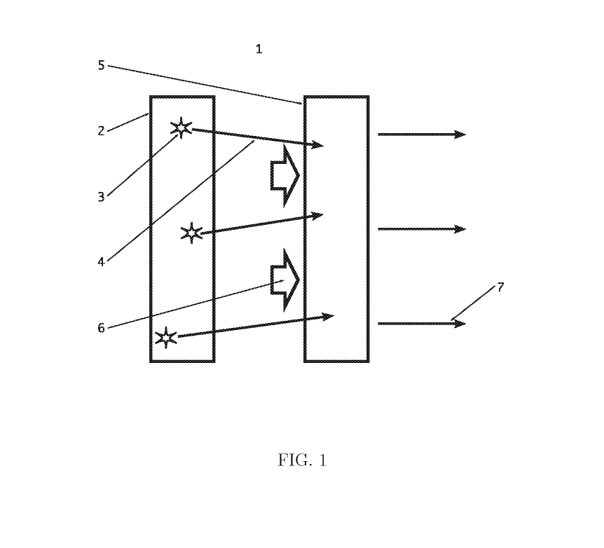

Reference is now made to FIG. 1. FIG. 1 shows an emitter electrode assembly [1] comprising a radioactive source [2] experiencing nuclear decay [3] resulting in emission of nuclear radiation [4] as one or a combination of α, β, or γ radiation. The nuclear radiation [4] strikes the emitter material [5], transferring energy in the form of heat [6] to the emitter material [5] and raising the temperature of the emitter material [5]. A thermoelectron current [7] emanates from the emitter material [5] as a result of the increased temperature.

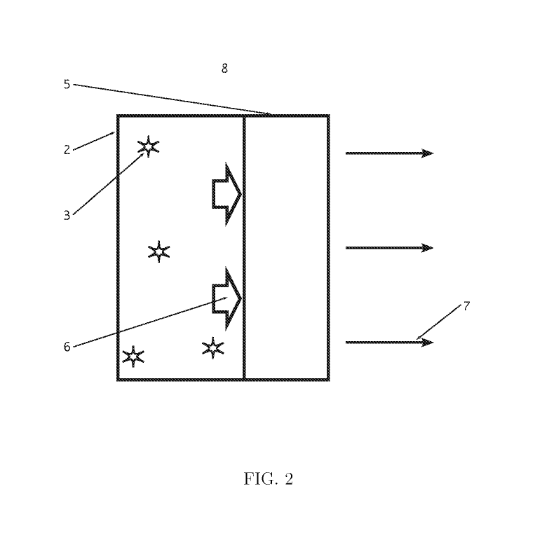

Reference is now made to FIG. 2. FIG. 2 shows an emitter electrode assembly [8] comprising a radioactive source [2] experiencing nuclear decay [3]. The nuclear decay [3] results in an increased temperature above ambient temperature of the radioactive source [2]. The radioactive source [2] is in direct thermal contact with the emitter material [5] and heat [6] is transferred from the radioactive source [2] to the emitter material [5], increasing the temperature of the emitter material [5] above ambient temperature. A thermoelectron current [7] emanates from the emitter material [5] as a result of the increased temperature.

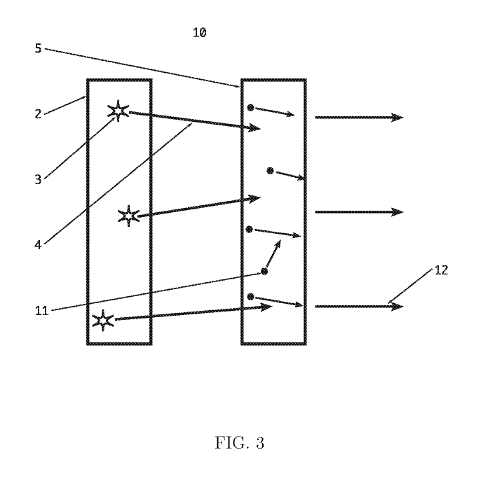

Reference is now made to FIG. 3. FIG. 3 shows an emitter electrode assembly [10] comprising a radioactive source [2] experiencing nuclear decay [3] resulting in emission of nuclear radiation [4] as one or a combination of α, β, or γ radiation. The nuclear radiation [4] from the radioactive source [2] strikes the emitter material [5] and produces a population of excited electrons [11] within the material. An emission current [12] comprised of some of the population of excited electrons [11] within the emitter electrode emitter material [5] emanates from the emitter material [5].

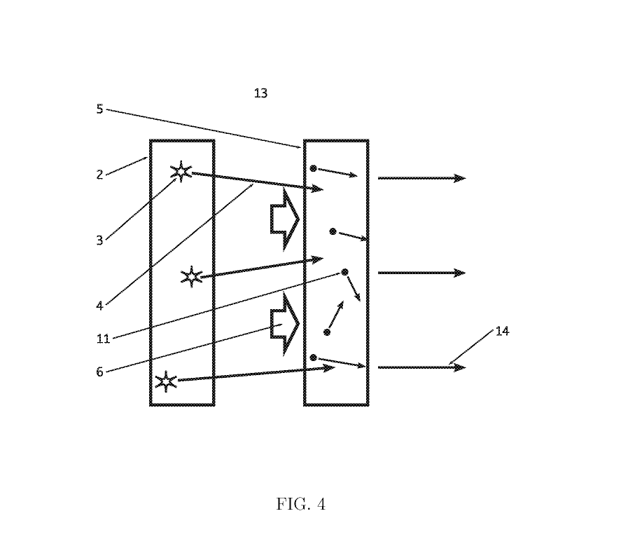

Reference is now made to FIG. 4. FIG. 4 shows an emitter electrode assembly [13] comprising a radioactive source [2] experiencing nuclear decay [3] resulting in emission of nuclear radiation [4] as one or a combination of α, β, or γ radiation. The nuclear radiation [4] from the radioactive source [2] strikes the emitter material [5] and produces a population of excited electrons [11] within the material. The nuclear radiation [4] striking the emitter material [5] also transfers energy in the form of heat [6] to the emitter material [5] and raises the temperature of the emitter material [5]. An enhanced thermoelectron current [14], enhanced by the population of excited electrons [11], emanates from the emitter material [5] as a result of the increased temperature.

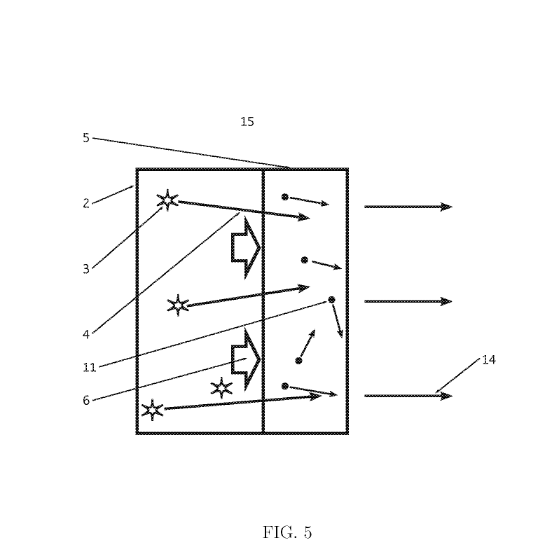

Reference is now made to FIG. 5. FIG. 5 shows an emitter electrode assembly [15] comprising a radioactive source [2] experiencing nuclear decay [3] resulting in emission of nuclear radiation [4] as one or a combination of α, β, or γ radiation. The nuclear radiation [4] from the radioactive source [2] enters the emitter material [5] and produces a population of excited electrons [11] within the material. The nuclear decay [3] also results in an increased temperature above ambient temperature of the radioactive source [2]. The radioactive source [2] is in direct thermal contact with the emitter material [5] and heat [6] is transferred from the radioactive source [2] to the emitter material [5], increasing the temperature of the emitter material [5] above the ambient temperature. An enhanced thermoelectron current [14], enhanced by the population of excited electrons [11], emanates from the emitter material [5] as a result of the increased temperature.

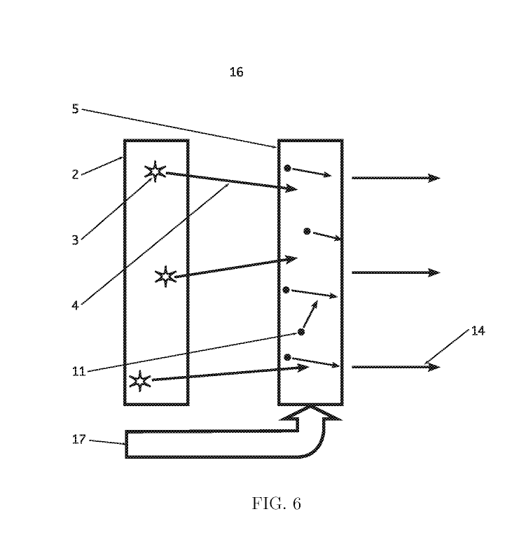

Reference is now made to FIG. 6. FIG. 6 shows an emitter electrode assembly [16] comprising a radioactive source [2] experiencing nuclear decay [3] resulting in emission of nuclear radiation [4] as one or a combination of α, β, or γ radiation. nuclear radiation [4] from the radioactive source [2] strikes the emitter material [5] and produces a population of excited electrons [11] within the material. A source external to the emitter material [5] and apart from the radioactive source [2] supplies heat [17] to the emitter material [5]. An enhanced thermoelectron current [14], enhanced by the population of excited electrons [11], emanates from the emitter material [5] as a result of the increased temperature.

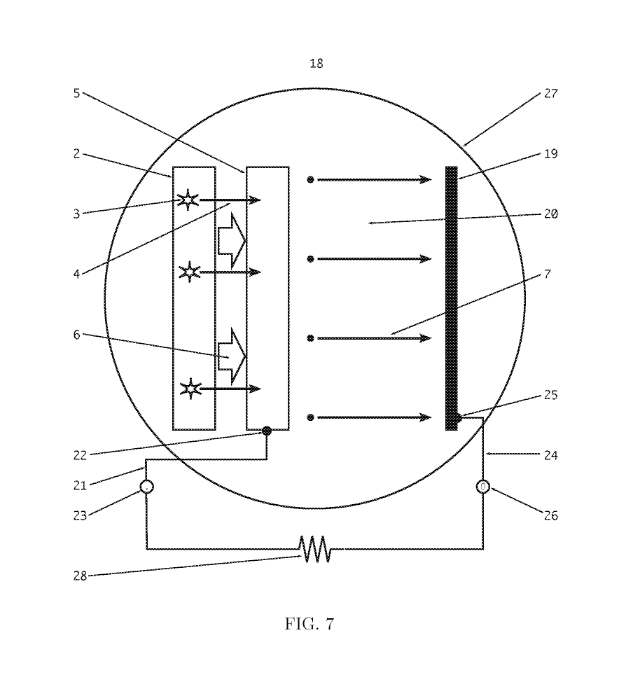

Reference is now made to FIG. 7. FIG. 7 shows a TEC [18] comprising an emitter material [5], a collector electrode [19] separated from the emitter material [5] by an interelectrode gap [20], a radioactive source [2] in the vicinity of the emitter material [5], an emitter lead [21] in electrical contact [22] to the emitter material [5] which penetrates the enclosure [27] and terminates outside the enclosure [27] at a positive electrical terminal [23], a collector lead [24] in electrical contact [25] to the collector electrode [19] which penetrates the enclosure [27] and terminates outside the enclosure [27] at a negative electrical terminal [26], and an enclosure [27] surrounding the emitter material [5], the collector electrode [19], and the radioactive source [2]. The enclosure [27] may be evacuated, partially evacuated, or contain some atmosphere of a gas or mixture of gases. The radioactive source [2] experiences nuclear decay [3] resulting in emission of nuclear radiation [4] as one or a combination of α, β, or γ radiation. The nuclear radiation [4] strikes the emitter material [5], transferring energy in the form of heat [6] to the emitter material [5] and raising the temperature of the emitter material [5]. A thermoelectron current [7] emanates from the emitter material [5] as a result of the increased temperature. The thermoelectron current [7] traverses the interelectrode gap [20] and arrives at the collector electrode [19] where it is absorbed. The electrical current will travel through an external electrical load [28] connected between the positive electrical terminal [23] and negative electrical terminal [26] and perform electrical work.

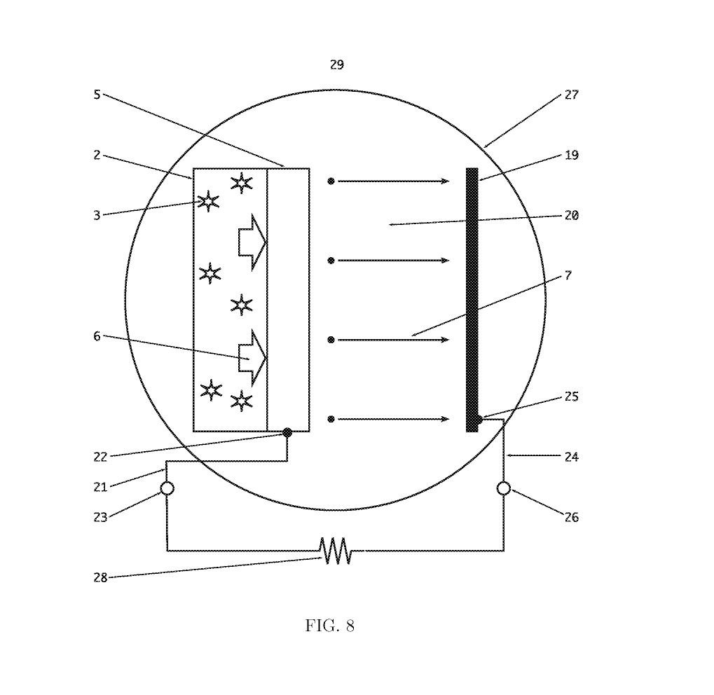

Reference is now made to FIG. 8. FIG. 8 shows a TEC [29] comprising an emitter material [5], a collector electrode [19] separated from the emitter material [5] by an interelectrode gap [20], a radioactive source [2] in direct thermal contact with the emitter material [5], an emitter lead [21] in electrical contact [22] to the emitter material [5] which penetrates the enclosure [27] and terminates outside the enclosure [27] at a positive electrical terminal [23], a collector lead [24] in electrical contact [25] to the collector electrode [19] which penetrates the enclosure [27] and terminates outside the enclosure [27] at a negative electrical terminal [26], and an enclosure [27] surrounding the emitter material [5], the collector electrode [19], and the radioactive source [2]. The enclosure [27] may be evacuated, partially evacuated, or contain some atmosphere of a gas or mixture of gases. The radioactive source [2] experiences nuclear decay [3] which results in an increased temperature above ambient temperature of the radioactive source [2]. The heat [6] transferred from the radioactive source [2] to the emitter material [5] results in the increase in temperature of the emitter material [5] above the ambient temperature. A thermoelectron current [7] emanates from the emitter material [5] as a result of the increased temperature. The thermoelectron current [7] traverses the interelectrode gap [20] and arrives at the collector electrode [19] where it is absorbed. The electrical current will travel through an external electrical load [28] connected between the positive electrical terminal [23] and negative electrical terminal [26] and perform electrical work.

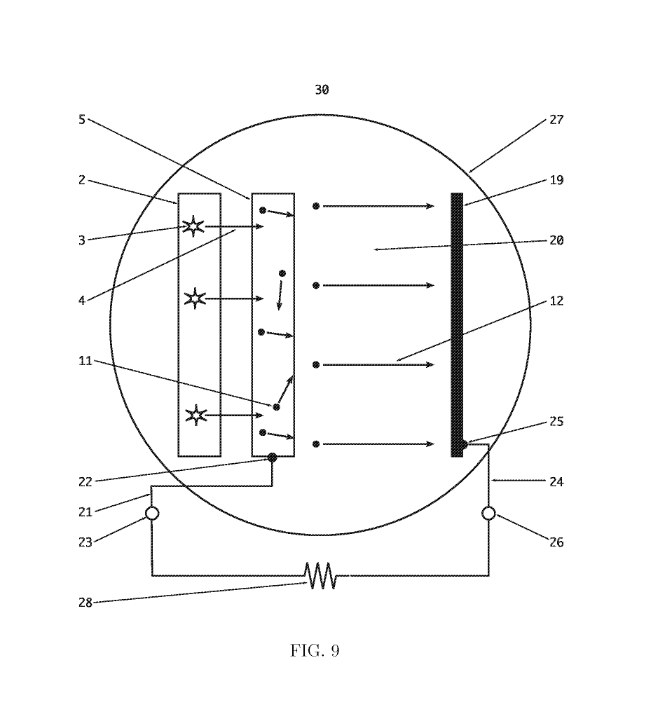

Reference is now made to FIG. 9. FIG. 9 shows a TEC [30] comprising an emitter material [5], a collector electrode [19] separated from the emitter material [5] by an interelectrode gap [20], a radioactive source [2] in the vicinity of the emitter material [5], an emitter lead [21] in electrical contact [22] to the emitter material [5] which penetrates the enclosure [27] and terminates outside the enclosure [27] at a positive electrical terminal [23], a collector lead [24] in electrical contact [25] to the collector electrode [19] which penetrates the enclosure [27] and terminates outside the enclosure [27] at a negative electrical terminal [26], and an enclosure [27] surrounding the emitter material [5], the collector electrode [19], and the radioactive source [2]. The enclosure [27] may be evacuated, partially evacuated, or contain some atmosphere of a gas or mixture of gases. The radioactive source [2] experiences nuclear decay [3] resulting in emission of nuclear radiation [4] as one or a combination of α, β, or γ radiation. The nuclear radiation [4] strikes the emitter material [5] and produces a population of excited electrons [11] within the material. An emission current [12] comprised of some of the population of excited electrons [11] within the emitter material [5] emanates from the emitter material [5]. The emission current [12] traverses the interelectrode gap [20] and arrives at the collector electrode [19] where it is absorbed. The electrical current will travel through an external electrical load [28] connected between the positive electrical terminal [23] and negative electrical terminal [26] and perform electrical work.

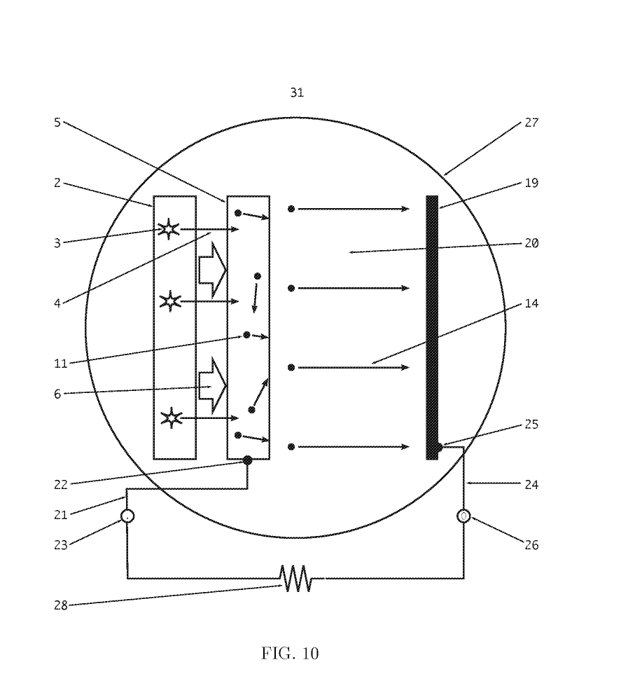

Reference is now made to FIG. 10. FIG. 10 shows a TEC [31] comprising an emitter material [5], a collector electrode [19] separated from the emitter material [5] by an interelectrode gap [20], a radioactive source [2] in the vicinity of the emitter material [5], an emitter lead [21] in electrical contact [22] to the emitter material [5] which penetrates the enclosure [27] and terminates outside the enclosure [27] at a positive electrical terminal [23], a collector lead [24] in electrical contact [25] to the collector electrode [19] which penetrates the enclosure [27] and terminates outside the enclosure [27] at a negative electrical terminal [26], and an enclosure [27] surrounding the emitter material [5], the collector electrode [19], and the radioactive source [2]. The enclosure [27] may be evacuated, partially evacuated, or contain some atmosphere of a gas or mixture of gases. The radioactive source [2] experiences nuclear decay [3] resulting in emission of nuclear radiation [4] as one or a combination of α, β, or γ radiation. The nuclear radiation [4] strikes the emitter material [5] and produces a population of excited electrons [11] within the material. The nuclear radiation [4] striking the emitter material [5] also transfers energy in the form of heat [6] to the emitter material [5] and raises the temperature of the emitter material [5]. A enhanced thermoelectron current [14], enhanced by the population of excited electrons [11], emanates from the emitter material [5]. The enhanced thermoelectron current [14] traverses the interelectrode gap [20] and arrives at the collector electrode [19] where it is absorbed. The electrical current will travel through an external electrical load [28] connected between the positive electrical terminal [23] and negative electrical terminal [26] and perform electrical work.

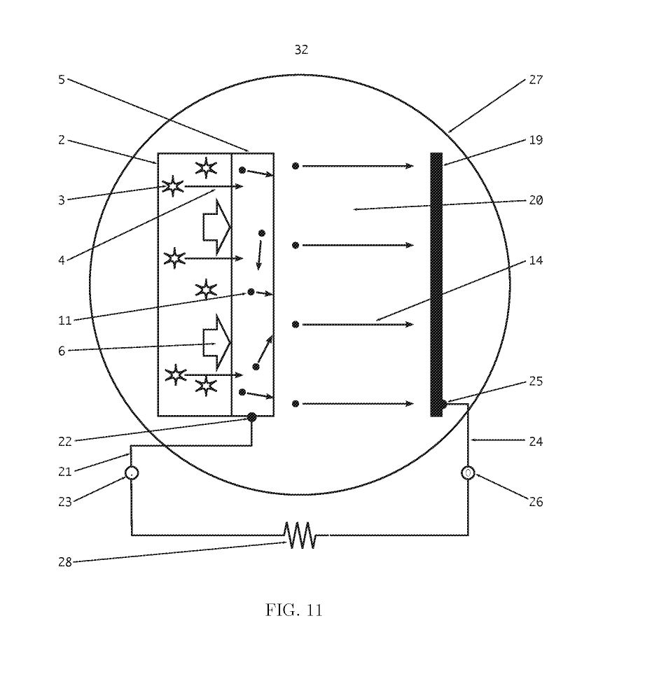

Reference is now made to FIG. 11. FIG. 11 shows a TEC [32] comprising an emitter material [5], a collector electrode [19] separated from the emitter material [5] by an interelectrode gap [20], a radioactive source [2] in direct thermal contact with the emitter material [5] an emitter lead [21] in electrical contact [22] to the emitter material [5] which penetrates the enclosure [27] and terminates outside the enclosure [27] at a positive electrical terminal [23], a collector lead [24] in electrical contact [25] to the collector electrode [19] which penetrates the enclosure [27] and terminates outside the enclosure [27] at a negative electrical terminal [26], and an enclosure [27] surrounding the emitter material [5], the collector electrode [19], and the radioactive source [2]. The enclosure [27] may be evacuated, partially evacuated, or contain some atmosphere of a gas or mixture of gases. The radioactive source [2] experiences nuclear decay [3] resulting in emission of nuclear radiation [4] as one or a combination of α, β, or γ radiation. The nuclear radiation [4] enters the emitter material [5] and produces a population of excited electrons [11] within the material. The nuclear decay [3] also results in an increased temperature above ambient temperature of the radioactive source [2]. The heat [6] transferred from the radioactive source [2] to the emitter material [5] results in the increase in temperature of the emitter material [5] above the ambient temperature. A enhanced thermoelectron current [14], enhanced by the population of excited electrons [11], emanates from the emitter material [5]. The enhanced thermoelectron current [14] traverses the interelectrode gap [20] and arrives at the collector electrode [19] where it is absorbed. The electrical current will travel through an external electrical load [28] connected between the positive electrical terminal [23] and negative electrical terminal [26] and perform electrical work.

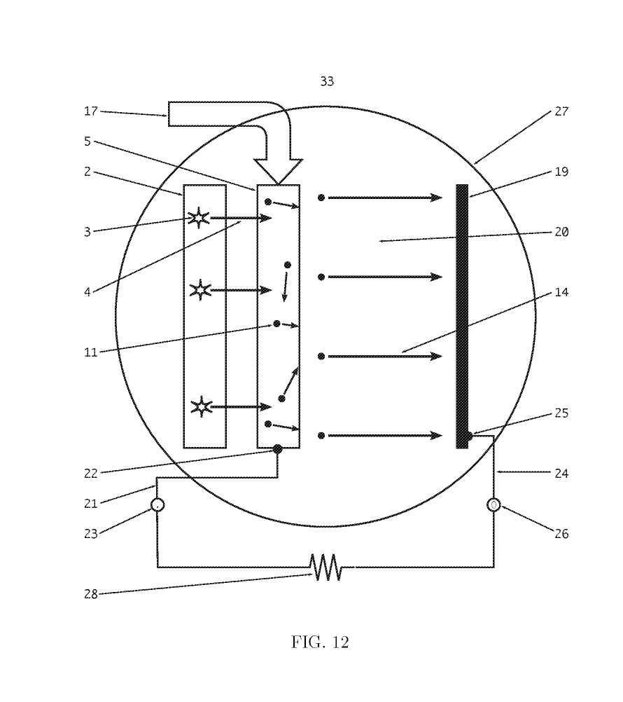

Reference is now made to FIG. 12. FIG. 12 shows a TEC [33] comprising an emitter material [5], a collector electrode [19] separated from the emitter material [5] by an interelectrode gap [20], a radioactive source [2] in the vicinity of the emitter material [5] an emitter lead [21] in electrical contact [22] to the emitter material [5] which penetrates the enclosure [27] and terminates outside the enclosure [27] at a positive electrical terminal [23], a collector lead [24] in electrical contact [25] to the collector electrode [19] which penetrates the enclosure [27] and terminates outside the enclosure [27] at a negative electrical terminal [26], and an enclosure [27] surrounding the emitter material [5], the collector electrode [19], and the radioactive source [2]. The enclosure [27] may be evacuated, partially evacuated, or contain some atmosphere of a gas or mixture of gases. The radioactive source [2] experiences nuclear decay [3] resulting in emission of nuclear radiation [4] as one or a combination of α, β, or γ radiation. The nuclear radiation [4] strikes the emitter material [5] and produces a population of excited electrons [11] within the material. A source external to the emitter material [5] and apart from the radioactive source [2] supplies heat [17] to the emitter material [5]. An enhanced thermoelectron current [14], enhanced by the population of excited electrons [11], emanates from the emitter material [5]. The enhanced thermoelectron current [14] traverses the interelectrode gap [20] and arrives at the collector electrode [19] where it is absorbed. The electrical current will travel through an external electrical load [28] connected between the positive electrical terminal [23] and negative electrical terminal [26] and perform electrical work.

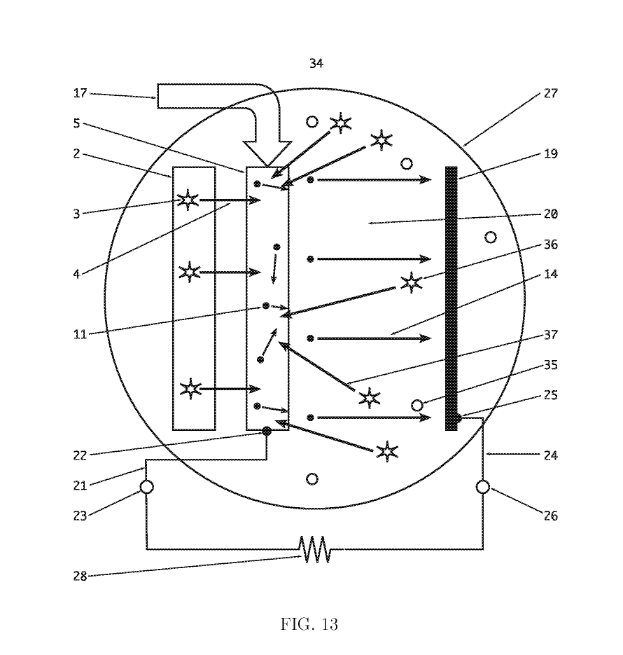

Reference is now made to FIG. 13. FIG. 13 shows a TEC [34] comprising an emitter material [5], a collector electrode [19] separated from the emitter material [5] by an interelectrode gap [20], a radioactive source [2] in the vicinity of the emitter material [5], a gaseous radioactive source [35], an emitter lead [21] in electrical contact [22] to the emitter material [5] which penetrates the enclosure [27] and terminates outside the enclosure [27] at a positive electrical terminal [23], a collector lead [24] in electrical contact [25] to the collector electrode [19] which penetrates the enclosure [27] and terminates outside the enclosure [27] at a negative electrical terminal [26], and an enclosure [27] surrounding the emitter material [5], the collector electrode [19], the radioactive source [2], and the gaseous radioactive source [35]. The enclosure [27] may be partially evacuated or contain some atmosphere of additional gas or mixture of gases. The radioactive source [2] experiences nuclear decay [3] resulting in emission of nuclear radiation [4] as one or a combination of α, β, or γ radiation. The gaseous radioactive source [35] also experiences nuclear decay [36], resulting in the emission of nuclear radiation [37] as one or a combination of α, β, or γ radiation. The nuclear radiation [4] strikes the emitter material [5] and produces a population of excited electrons [11] within the material. Additional nuclear radiation [37] from the gaseous radioactive source [35] also strikes the emitter material [5], increasing the population of excited electrons [11]. A source external to the emitter material [5] and apart from the radioactive source [2] supplies heat [17] to the emitter material [5]. An enhanced thermoelectron current [14], enhanced by the population of excited electrons [11], emanates from the emitter material [5]. The enhanced thermoelectron current [14] traverses the interelectrode gap [20] and arrives at the collector electrode [19] where it is absorbed. The electrical current will travel through an external electrical load [28] connected between the positive electrical terminal [23] and negative electrical terminal [26] and perform electrical work.

Having thus described several aspects of at least one embodiment of this disclosed subject matter, it is to be appreciated various alterations, modifications, and improvements will readily occur to those skilled in the art. Such alterations, modifications, and improvements are intended to be part of this disclosure, and are intended to be within the spirit and scope of the disclosed subject matter. Accordingly, the foregoing description and drawings are by way of example only.

What is claimed:

1. An electrode assembly comprising:
an emitter material
one or more radioactive sources experiencing nuclear decay in the vicinity of the emitter material

2. The electrode assembly from claim 1 wherein the radioactive source or sources emit one or a combination of α, β, or γ radiation.

3. The electrode assembly of claim 2 wherein the nuclear radiation from a radioactive source strikes the emitter material and transfers energy to the emitter material in the form of heat.

4. The electrode assembly of claim 3 wherein the heat from nuclear radiation causes a thermoelectron emission current to emanate from the emitter material.

5. The electrode assembly of claim 1 wherein the emitter material and a radioactive source are in direct thermal contact.

6. The electrode assembly of claim 5 wherein the radioactive source is at a temperature above ambient due to its own nuclear decay.

7. The electrode assembly of claim 6 wherein heat is transferred from the radioactive source to the emitter material and the temperature of the emitter material is elevated above ambient.

8. The electrode assembly of claim 7 wherein the heat from the radioactive source causes a thermoelectron emission current to emanate from the emitter material.

9. The electrode assembly of claim 2 wherein the nuclear radiation from a radioactive source strikes the emitter material and a population of excited electrons is produced within the emitter material.

10. The electrode assembly of claim 9 wherein a portion of the population of excited electrons escape the emitter material and are emitted as an electric current.

11. The electrode assembly of claim 9 wherein the nuclear radiation from a radioactive source transfers energy to the emitter material in the form of heat.

12. The electrode assembly of claim 11 wherein the heat from the nuclear radiation causes a thermoelectron emission current to emanate from the emitter material, and the thermoelectron emission current is enhanced by the population of excited electrons within the emitter material.

13. The electrode assembly of claim 9 wherein the emitter material and a radioactive source are in direct thermal contact.

14. The electrode assembly of claim 13 wherein the radioactive source is at a temperature above ambient due to its own nuclear decay.

15. The electrode assembly of claim 14 wherein heat is transferred from the radioactive source to the emitter material and the temperature of the emitter material is elevated above ambient.

16. The electrode assembly of claim 15 wherein the heat from the nuclear decay causes a thermoelectron emission current to emanate from the emitter material, and the thermoelectron emission current is enhanced by the population of excited electrons within the emitter material.

17. The electrode assembly of claim 9 wherein heat is supplied from a source external to the electrode assembly and apart from any heat transferred from the radioactive source to the emitter material.

18. The electrode assembly of claim 17 wherein the heat from the external source causes a thermoelectron emission current to emanate from the emitter material, and the thermoelectron emission current is enhanced by the population of excited electrons within the emitter material.

19. A thermoelectron energy converter (TEC) comprising:
an emitter electrode
a collector electrode
an enclosure surrounding the emitter electrode and collector electrode
an electrical lead making electrical contact with the emitter electrode, penetrating the enclosure and terminating at an electrical terminal outside the enclosure
an electrical lead making electrical contact with the collector electrode, penetrating the enclosure and terminating at an electrical terminal outside the enclosure
one or more a radioactive sources experiencing nuclear decay in the vicinity of the emitter electrode.

20. The TEC from claim 19 wherein a radioactive source or sources emit nuclear radiation in the form of one or a combination of α, β, or γ radiation.

21. The TEC from claim 20 wherein nuclear radiation from a radioactive source strikes the emitter electrode and transfers energy to the emitter electrode in the form of heat.

22. The TEC of claim 21 wherein the heat from nuclear radiation causes a thermoelectron emission current to emanate from the emitter electrode.

23. The TEC of claim 22 wherein the thermoelectron current traverses the TEC and is subsequently collected by the collector electrode.

24. The TEC from claim 19 wherein the emitter electrode and a radioactive source in direct thermal contact.

25. The TEC from claim 24 wherein the radioactive source is at a temperature above ambient temperature due to its own nuclear decay.

26. The TEC from claim 25 wherein heat is transferred from the radioactive source to the emitter electrode and the temperature of the emitter electrode is elevated above the ambient temperature.

27. The TEC from claim 26 wherein the heat from the radioactive source causes a thermoelectron emission current to emanate from the emitter electrode.

28. The TEC from claim 27 wherein the thermoelectron current traverses the TEC and is subsequently collected by the collector electrode.

29. The TEC from claim 20 wherein the nuclear radiation from a radioactive source strikes the emitter electrode and a population of excited electrons is produced within the emitter electrode.

30. The TEC of claim 29 wherein a portion of the population of excited electrons escape the emitter electrode and are emitted as an emission current.

31. The TEC of claim 30 wherein the emission current traverses the TEC and is subsequently collected by the collector electrode.

32. The TEC from claim 29 wherein the nuclear radiation from a radioactive source also transfers energy to the emitter electrode in the form of heat.

33. The TEC of claim 32 wherein the heat from nuclear radiation causes a thermoelectron emission current to emanate from the emitter electrode which is enhanced by the population of excited electrons within the emitter electrode.

34. The TEC of claim 33 wherein the enhanced emission current traverses the TEC and is subsequently collected by the collector electrode.

35. The TEC from claim 29 wherein the emitter electrode and a radioactive source in direct thermal contact.

36. The TEC from claim 35 wherein the radioactive source is at a temperature above ambient temperature due to its own nuclear decay.

37. The TEC from claim 36 wherein heat is transferred from the radioactive source to the emitter electrode and the temperature of the emitter electrode is elevated above the ambient temperature.

38. The TEC from claim 37 wherein the heat from the radioactive source causes a thermoelectron emission current to emanate from the emitter electrode which is enhanced by the population of excited electrons within the emitter electrode.

39. The TEC of claim 38 wherein the enhanced emission current traverses the TEC and is subsequently collected by the collector electrode.

40. The TEC from claim 29 wherein the emitter electrode and a source of heat external to the electrode and apart from any heat transferred from a radioactive source to the emitter electrode.

41. The TEC of claim 40 wherein the heat from the external source causes a thermoelectron emission current to emanate from the emitter electrode which is enhanced by the population of excited electrons within the emitter electrode.

42. The TEC of claim 41 wherein the enhanced emission current traverses the TEC and is subsequently collected by the collector electrode.
